(19) United States
(12) Patent Application Publication
(10) Pub. No.: US 2018/0163867 A1
(43) Pub. Date: Jun. 14, 2018

(54) METHOD AND APPARATUS FOR ACHIEVING ANTI-STRAIN VIA ROUTING

(71) Applicants: Chuan-Chung WANG, New Taipei City (TW); Wilson Wen-Tsung CHUNG, Taipei City (TW)

(72) Inventors: Chuan-Chung WANG, New Taipei City (TW); Wilson Wen-Tsung CHUNG, Taipei City (TW)

(21) Appl. No.: 15/463,586

(22) Filed: Mar. 20, 2017

(30) Foreign Application Priority Data
Dec. 9, 2016 (TW) 105140814

(51) Int. Cl. F16J 15/02

(52) U.S. Cl. CPC F16J 15/022

(57) ABSTRACT

A method and apparatus for achieving anti-strain via routing, which mainly includes a receiving section for firstly receiving a first external force and a strain generated from the first external force before extensible inclined sections disposed at two ends of the receiving section route a subsequently resulted stress into a groove section for absorption, so as to generate a uniformized stress, which provides an advantageous method capable of flexibly reducing strain by a routing process. The apparatus can be embedded in water-stopping components such as rubber anti-shock connectors, rubber soft joint shock absorbers, waterproof washers or O-rings, which reinforces the effects of water-stoppage and waterproof, and effectively prevents rubber components from fracturing caused by aging and external pressure.

### BACKGROUND OF THE INVENTION

a) Field of the Invention

The present invention relates to a method and apparatus for achieving anti-strain via routing; which is applicable in water-stopping components like rubber anti-shock connectors, rubber soft joint shock absorbers, waterproof washers or O-rings, wherein a receiving section is used for firstly receiving a first external force, and the receiving section then receives a strain generated from the first external force before extensible inclined sections disposed at two ends of the receiving section route a subsequently resulted stress into a groove section for absorption so as to generate a uniformized stress, which provides an advantageous method capable of flexibly reducing strain by a routing process. Moreover, a ring disposed with a plurality of sequentially arranged receiving sections, inclined section, groove sections, inclined sections and so on is provided on the basis of the method, which reinforces effects of water-stoppage and waterproof, and protects water-stopping components such as rubber anti-shock connectors, rubber soft joint shock absorbers, waterproof washers or O-rings from being distorted and fractured by the strain generated at an interface where two components are tightly fastened together.
b) Description of the Prior Art

Generally, when a material is under the action of an external force but cannot move positionally, its geometric shape and size are changed as a result, and the deformation is known as strain. When the material is deformed in its shape, a counterforce that is equal to the external force in strength but opposite to the direction of the external force occurs internally in order to counter the external force. Such a counterforce occurring on a defined unit area is known as stress. Alternately, an object may be deformed due to an external factor (such as being under a force or experience changes in humidity . . . etc.), and counter-acting internal forces occur inside different parts of the object in order to counter the external actions, and such forces attempt to return the deformed object back to its original shape. An internal force exerted on a point within a unit area from a cross section under investigation is known as stress. Stress can be further divided into normal stress a and shear stress T according to a directional relationship between stress and strain; the direction of the normal stress is parallel to the direction of the strain, while the direction of the shear stress is perpendicular to the direction of the strain. According to different forms in the actions of load, stress can also be divided into tension and compression stress, bending stress and torsional stress.

When a material has an external force exerted thereon but cannot move positionally, its geometric shape and size are modified as a result, and the deformation is known as strain. When the material is deformed in its shape, a counterforce that is equal to the external force in strength but opposite to the direction of the external force occurs in order to counter the external force. Such a counterforce on a defined unit area is known as stress.

In the traditional rubber anti-shock connectors, rubber soft joint shock absorbers, O-rings or waterproof washers, and especially in the rubber anti-shock connectors and rubber soft joint shock absorbers, circular steel cables are usually embedded around the openings of such components in order to reinforce the fixing and water-stoppage effects. The method of reinforcing air-tightness and fixture of the rubber shock absorbers and reducing pressure by using the steel cables had been in practice for many years. However, in the traditional rubber anti-shock connectors, rubber soft joint shock absorbers, O-rings or waterproof washers, and especially in the rubber anti-shock connectors and rubber soft joint shock absorbers, the applied steel cables are made from weaving together a plurality of steel wires. When an installed rubber anti-shock connector is pressed by a flange, an opening of the rubber anti-shock connector expands outwardly and becomes flattened. After being used for a period of time, the fastened nuts and bolts of the flange become loosened and require regular checks for fastening of components and leakage, and the problem of the components becoming distorted and fractured by a stress generated at an interface where two surfaces are tightly fastened together arises, which leads to deformation in the rubber and the steel cables (a circular shape is pressed into an oval shape) and resulted in reduced water-stoppage effect. Further, another problem of water leakage in a rubber anti-shock connector also frequently occurs as some steel wires can also protrude and damage the perimeter of the rubber anti-shock connector.

In light of the shortcomings of the prior art, the inventor of the present invention has strived to provide a method and apparatus for achieving anti-strain via routing, as described in the following paragraphs.

### SUMMARY OF THE INVENTION

In light of the drawbacks of the prior art mentioned above, the present invention provides a method and apparatus for achieving anti-strain via routing, which aims to reinforce effects of water-stoppage and waterproof, and in turn protect rubber components from fracturing caused by aging and external pressure, and can be used to replace steel cables in order to solve the problem of steel cables getting pressed and cracked into steel wires that consequently cut into rubber.

Another aim of the method and apparatus for achieving anti-strain via routing of the present invention is to provide an apparatus that is convenient and easy to manufacture, and can be easily provided with reinforced effects of water-stoppage and waterproof, thereby protecting water-stopping components such as rubber anti-shock connectors, rubber soft joint shock absorbers, waterproof washers or O-rings from becoming distorted and fractured by the strain generated at an interface where two components are tightly fastened together.

To achieve the aforesaid and other purposes, the present invention has proposed a method and apparatus for achieving anti-strain via routing, which is suitable to be used in water-stopping components such as rubber anti-shock connectors, rubber soft joint shock absorbers, waterproof washers or O-rings.

According to the present invention, the method and apparatus for achieving anti-strain via routing mainly includes a receiving section for firstly receiving a first external force, and the receiving section then receives a strain generated from the first external force, before extensible inclined sections disposed at two ends of the receiving section route a stress generated from the strain into a groove section for absorption so as to generate a uniformized stress, which provides an advantageous method capable of flexibly reducing strain by a routing process.

A method and apparatus for achieving anti-strain via routing have been proposed in the present invention, in which a ring apparatus disposed with a plurality of sequentially arranged receiving sections, inclined sections, groove sections, inclined sections and so on is provided on the basis of the proposed method.

The receiving sections and the groove sections are disposed as circular in shape, and can be in other shapes as well, such that the overall ring apparatus comprises continuous arrangements of one receiving section being next to one groove section.

An inclined section is disposed between each of the receiving sections and each of the groove sections.

And the inclined section has an adequate angle of inclination.

Therefore, a method and apparatus for achieving anti-strain via routing has been proposed in the present invention, which provides an advantageous method capable of flexibly reducing strain by a routing process, and the apparatus for achieving anti-strain via routing can be embedded in water-stopping components like rubber anti-shock connectors, rubber soft joint shock absorbers, waterproof washers or O-rings. Hence, not only effects like water-stoppage and waterproof can be reinforced, rubber components can be effectively prevented from fracturing caused by aging and external pressure, and the apparatus can be used to replace steel cables, thereby overcoming the problem of having steel cables getting pressed and cracked into steel wires by flanges, which subsequently cut into rubber. Consequently, water-stopping components such as the rubber anti-shock connectors, rubber soft joint shock absorbers, waterproof washers or O-rings are protected from becoming distorted and fractured by the strain generated at an interface where two components are tightly fastened together, which is the main purpose of the present invention.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is a flow chart showing a method according to the present invention.

FIG. 2 is a schematic top view showing an apparatus according to the present invention.

FIG. 3 is a schematic lateral view showing an enlarged part of the apparatus according to the present invention.

### DETAILED DESCRIPTION OF THE PREFERRED EMBODIMENTS

The advantages and effects of the present invention can be easily understood by anyone skilled in the art by referring to the disclosure in this description, and to the specific examples, explanations and accompanying embodiments of the present invention. The present invention can also be implemented or applied by using other different embodiments, and details in this description can be edited and modified on the basis of various viewpoints and applications, as long as they do not depart from the scope and spirit of the present invention.

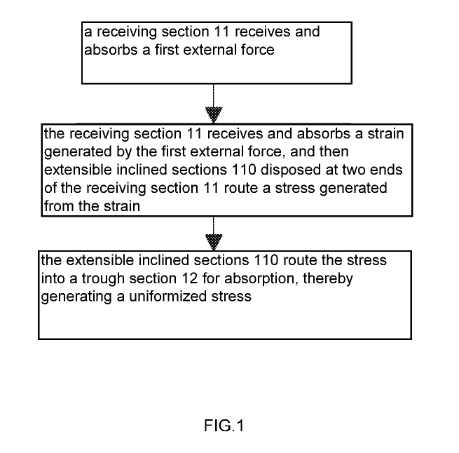

Refer to FIG. 1, which is a method and apparatus for achieving anti-strain via routing according to the present invention, comprising:

a receiving section 11 firstly receives and absorbs a first external force;

the receiving section 11 receives and absorbs a strain generated from the first external force, and extensible inclined sections 110 disposed at two ends of the receiving section 11 route a stress generated from the strain;

the extensible inclined sections 110 route the stress into a groove section 12 for absorption so as to generate a uniformized stress, which provides an advantageous method capable of flexibly reducing strain by a routing process.

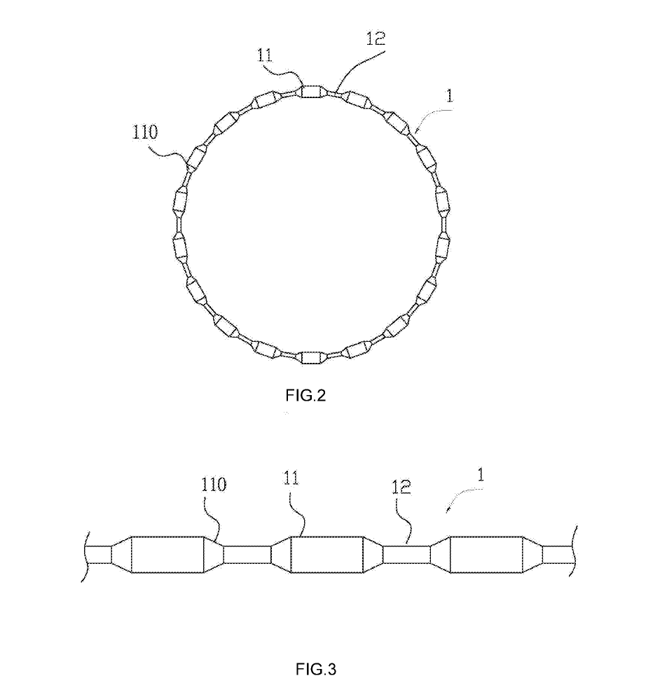

Refer to FIGS. 2 and 3, which show the method and apparatus for achieving anti-strain via routing, and provides a ring apparatus 1 disposed with a plurality of sequentially arranged receiving sections 11, inclined sections 110, groove sections 12, inclined sections 110 and so on according to the method, wherein:

The receiving section 11 is wider in width.

The groove section 12 is narrower in width.

The receiving section 11 and the groove section 12 are disposed as circular in shape, and can be in other shapes as well, such that the entire ring apparatus 1 comprises continuous arrangements of one receiving section 11 being next to one groove section 12.

An inclined section 110 is disposed between each of the receiving sections 11 and each of the groove sections 12.

And the inclined section 110 has an adequate angle of inclination.

Therefore, a ring apparatus 1 basing on the method for achieving anti-strain via routing can be conveniently and easily manufactured according to the present invention, which provides an advantageous method capable of flexibly reducing strain by a routing process.

Basing on the concept described above, the apparatus for achieving anti-strain via routing can be embedded in water-stopping components like rubber anti-shock connectors, rubber soft joint shock absorbers, waterproof washers or O-rings, in which a receiving section 11 firstly receives a first external force, then a stress is generated from a strain resulted from the external force and routed by extensible inclined sections 110 disposed at two ends of the receiving section 11 into a groove section 12 for absorption, and subsequently generating a uniformized stress. As a result, effects like water-stoppage and waterproof can be reinforced, and rubber components can be effectively prevented from fracturing caused by aging and external pressure. The apparatus can be used to replace steel cables in order to solve the problem of steel cables being pressed and cracked into steel wires by flanges, which consequently cut into rubber. Consequently, water-stopping components such as rubber anti-shock connectors, rubber soft joint shock absorbers, waterproof washers or O-rings are protected from becoming distorted and fractured by a strain generated at an interface where two components are tightly fastened together, which reinforces water-stoppage and waterproof effects and fulfills the main purpose of the present invention.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A method for achieving anti-strain via routing, comprising:
a receiving section firstly receiving and absorbing a first external force;
the receiving section receiving and absorbing a strain generated from the first external force, and extensible inclined sections disposed at two ends of the receiving section routing a stress generated from the strain;
the extensible inclined sections routing the stress into a groove section for absorption so as to generate a uniformized stress.

2. An apparatus for achieving anti-strain via routing, comprising a ring apparatus disposed with a plurality of sequentially arranged wider receiving sections, inclined sections, narrower groove sections, and inclined sections, wherein:
each of the inclined sections is disposed between each of the receiving sections and each of the groove sections;
